(19) United States
(12) Patent Application Publication
(10) Pub. No.: US 2014/0046709 A1
(43) Pub. Date: Feb. 13, 2014

(54) METHODS AND SYSTEMS FOR EVALUATING TECHNOLOGY ASSETS

(71) Applicants: Mark Clement Kwapiszeski, Dardenne Prairie, MO (US); Stephanie Michelle Dickinson, Collinsville, IL (US); Matthew Thomas Holton, Wentzville, MO (US)

(72) Inventors: Mark Clement Kwapiszeski, Dardenne Prairie, MO (US); Stephanie Michelle Dickinson, Collinsville, IL (US); Matthew Thomas Holton, Wentzville, MO (US)

(21) Appl. No.: 13/570,090

(22) Filed: Aug. 8, 2012

(51) Int. Cl. G06Q 10/06

(52) U.S. Cl. 705/7.11

(57) ABSTRACT

A technology maturity evaluation (TME) computer device is provided for evaluating a technology asset of an entity is provided. The TME computer device includes a memory device for storing data including a plurality of business value questions and a plurality of technical maturity questions, and a processor in communication with the memory device. The TME computer device is programmed to receive an asset identifier identifying an asset selected for evaluation and to electronically display business value questions and technical maturity questions for the selected asset, wherein each question is designated for a response by a subject matter expert. The TME computer device is further programmed to receive response data from each of the subject matter experts and calculate a business value score and a technical maturity score for the selected asset based on the response data.

### BACKGROUND OF THE DISCLOSURE

The embodiments described herein relate generally to asset evaluation and, more particularly, to methods and systems for evaluating technology assets including comparing the technical maturity of various technology assets owned by an entity to the business values of the entity.

Evaluating investments in assets is an important part of improving the value and profitability of a company. The increase in popularity and competition in the software application industry over the last decade has created a necessity for companies to maximize the returns on the investments they make to develop such applications.

Most known evaluation systems evaluate software applications by questioning technology developers and/or engineers about achieved and projected business values of various applications. However, the questions asked typically allow for subjective answers from the developers and/or engineers. Accordingly, the evaluations are often times subjective and may reflect the agendas of the developers and/or engineers. Thus, these known systems fail to provide an accurate evaluation of the software applications. Moreover, these known systems generally evaluate assets only on an individual level without providing a comparison to the other assets owned by the same company.

Accordingly, it is desirable to evaluate technology assets in an accurate and objective manner, and to provide a comparison of all evaluated assets based on the business values and technical states of the assets.

### BRIEF DESCRIPTION

In one embodiment, a technology maturity evaluation (TME) computer device is provided for evaluating a technology asset of an entity is provided. The TME computer device includes a memory device for storing data including a plurality of business value questions and a plurality of technical maturity questions, and a processor in communication with the memory device. The TME computer device is programmed to receive an asset identifier identifying an asset selected for evaluation and to electronically display business value questions and technical maturity questions for the selected asset, wherein each question is designated for a response by a subject matter expert. The TME computer device is further programmed to receive response data from each of the subject matter experts and calculate a business value score and a technical maturity score for the selected asset based on the response data.

In another embodiment, a computer-implemented method is provided for evaluating a technology asset of an entity using a technology maturity evaluation (TME) computer device. The TME computer device includes a memory device for storing data including a plurality of business value questions and a plurality of technical maturity questions, and a processor in communication with the memory device. The method includes receiving, by the TME computer device, an asset identifier identifying an asset selected for evaluation and electronically displaying a plurality of business value questions and a plurality of technical maturity questions. Each of the questions is designated for a response by a subject matter expert. The method further includes receiving response data from each of the subject matter experts and calculating a business value score and a technical maturity score for the selected asset based at least in part on the response data. The business value score represents an overall value and impact the selected asset has in a marketplace, and the technical maturity score represents an amount of resources invested to develop and implement the selected asset.

In yet another embodiment, one or more non-transitory computer-readable storage media is provided for evaluating a technology asset of an entity by a technology maturity evaluation (TME) computer device. The TME computer device includes a memory device and a processor. The computer-readable storage media have computer-executable instructions embodied thereon. When executed by the processor, the computer-executable instructions cause the processor to receive an asset identifier identifying an asset selected for evaluation and to electronically display business value questions and technical maturity questions for the selected asset. Each question is designated for a response by a subject matter expert. The business value questions are configured to evaluate an overall value and impact an asset has in a marketplace and the technical maturity questions are configured to evaluate an amount of resources invested to develop and implement the asset. The computer-executable instructions further cause the processor to receive response data from each of the subject matter experts and calculate a business value score and a technical maturity score for the selected asset based on the response data.

### BRIEF DESCRIPTION OF THE DRAWINGS

FIGS. 1-11 show example embodiments of the method and system described herein.

FIG. 1 is a simplified block diagram of an example embodiment of an asset evaluation computer system including a technology maturity evaluation (TME) computer device in accordance with one embodiment of the present invention.

FIG. 2 is an expanded block diagram of an example embodiment of a server architecture of an asset evaluation computer system, including the TME computer device shown in FIG. 1 in accordance with one embodiment of the present invention.

FIG. 3 is a block diagram of an example embodiment of a user computer device as shown in FIGS. 1 and 2.

FIG. 4 is a block diagram of an example embodiment of a server computer device as shown in FIGS. 1 and 2.

FIG. 5 is a data flow diagram showing a process implemented by the TME computer device shown in FIGS. 1 and 2 for evaluating technology assets in accordance with one embodiment of the present invention.

FIG. 6 is a screenshot of a reporting screen from the TME computer device shown in FIGS. 1 and 2 in accordance with an example embodiment of the present invention.

FIG. 7 is a chart that illustrates exemplary questions and answers posed to subject matter experts by the TME computer device shown in FIGS. 1, 2, and 6 in accordance with an example embodiment of the present invention.

FIG. 8 shows an example summary report at an asset level as outputted by the TME computer device shown in FIGS. 1, 2, and 6 in accordance with an example embodiment of the present invention.

FIG. 9 is an example graph generated by the TME computer device shown in FIGS. 1 and 2 illustrating the maturity of a plurality of assets relative to one another.

FIG. 10 is an example graph generated by the TME computer device shown in FIGS. 1 and 2 illustrating the maturity of a plurality of asset platforms relative to one another.

FIG. 11 is a screenshot generated by the TME computer device shown in FIGS. 1 and 2 illustrating the technical maturity scores for a plurality of assets at a category and a sub-category level.

FIG. 12 is a screenshot of a modeling function of the TME computer device shown in FIGS. 1 and 2.

### DETAILED DESCRIPTION OF THE DISCLOSURE

Embodiments of the present invention described herein relate to methods and systems for determining a technical maturity of a company's assets, and comparing the assets using the determined technical maturity to an associated business value. The assets are compared using a computer system, such as a technology maturity evaluation (TME) computer device. In the example embodiment, the assets compared by the TME computer device are typically software applications or other technology assets associated with a company or a portfolio. In other embodiments, the TME computer device may compare any assets capable of having a technical maturity. Technical maturity as used herein means represents an amount of resources and processes that the company has invested to develop and implement an asset, and may be represented by factors such as reliability, availability, maintainability, customer delivery, process governance and/or any other factor deemed important to the implementation of an asset.

For example, during operation, a user, or analyst, selects a plurality of assets for the TME computer device to compare. For the specified assets to be evaluated, the TME computer device is configured to provide a plurality of questions relating to a business value and the technical maturity of the asset. Business value as used herein means an overall value and impact an asset has in a market, including the amount of business and revenue the asset generates on behalf of a company. In the example embodiment, the business value questions are associated with different categories related to the business aspect of the asset, such as volume, exposure, profitability, and expected growth. Each asset is given a business value score and a technical maturity score based on the answers to the business value questions and the technical maturity questions, so they may be compared to the other assets selected for comparison.

To provide an accurate evaluation of the assets, achieving objectivity in the responses to the questions is desirable. To achieve objectivity, the TME computer device (i) poses the same questions for each asset, regardless of its purpose or size of operation, (ii) poses the questions to “subject matter experts”, who are personnel with appropriate business or technical knowledge relating to the asset to answer the questions (i.e. business analysts/executives answer business value questions and technology managers answer technical maturity questions and technical subject matter experts answer questions related to their fields of expertise), and (iii) provides multiple-choice answers to each of the questions to provide a scaled, multiple-tier analysis for differentiation in the scoring of the assets.

Upon submission of the answers by the subject matter experts, the TME computer device receives the answers to the questions (also referred to as “response data”). The TME computer device stores the response data in a database, so that the response data can be accessed in the future for other comparisons or analysis. The TME computer device then analyzes the responses and determines a business value score and a technical maturity score for each asset. The analyst may weigh each question by importance, so that when comparing multiple assets, certain characteristics may be highlighted, or given more importance. Each question may be associated with a category and a sub-category which may also be separately weighted for scoring purposes. The categories and subcategories assist in analyzing assets by determining scores for specific aspects of the asset, so that strengths and weaknesses relating to technical maturity can be determined for specific areas.

Having calculated the business value scores and the technical maturity scores for the assets, the TME computer device then generates a graphical representation for comparing the analyzed assets relative to one another. The graph displays a point, or bubble, representing each asset. The business value is represented on the vertical axis and the technical maturity is represented on the horizontal axis. The sizes of the bubbles represent the total amount of money that the company has invested in the asset over a specified time, for example, a calendar year. The graph enables the analyst to look at the technical maturity of an asset and assess the areas where the asset's technology is adequate, and where it needs more investment to optimize the business value. Each asset on the graph may be selected by the analyst to view more detailed scores and a recommendation of a planned action to take for the asset.

The graph may also be displayed at a platform level, where a platform represents a plurality of assets associated with a specific division or business aspect of the company. Thus, the graph at the platform level indicates an overall technical maturity of the plurality of assets associated with the division and how the technical maturity of that division's platform relates to that platform's business value, and how the technical maturity relates to other platforms associated with the company.

The methods and systems described herein may be implemented using computer programming or engineering techniques including computer software, firmware, hardware or any combination or subset thereof, wherein the technical effect may include at least one of: (i) receiving, by a technology maturity evaluation (TME) computer device, a list of assets to be compared; (ii) providing, by the TME computer device, business value questions and technical maturity questions to appropriate subject matter experts through at least one user computer device, wherein the business value questions and technical maturity questions are identical for all assets being evaluated and have multiple-choice answers; (iii) receiving, at the TME computer device, response data from the subject matter experts through the at least one user computer device, wherein the response data is data associated with the answers to the business value questions and the technical maturity questions provided by the subject matter experts; (iv) determining a business value score and a technical maturity score for each asset based on the response data; and (v) generating a graphical representation comparing the technical maturity score of each asset to the business value score of each asset relative to the other assets being compared.

The following detailed description illustrates embodiments of the invention by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, systems and methods of objectively evaluating technology assets, and generating a graph for comparing the assets based on their technical maturity as related to their business value. However, it is contemplated that this disclosure has general asset to computing systems in industrial, commercial, and residential assets.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

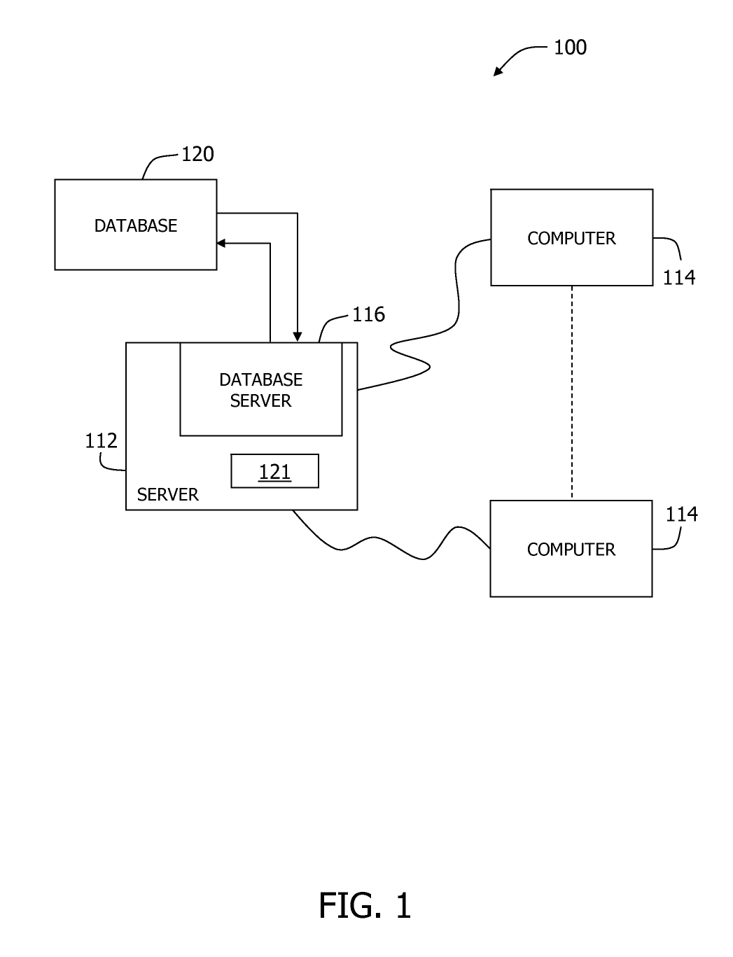

FIG. 1 is a simplified block diagram of an example embodiment of an asset evaluation computer system 100 including a technology maturity evaluation (TME) computer device in accordance with one embodiment of the present invention. In the example embodiment, computer system 100 is configured to evaluate assets relative to all other assets associated with a company or a company's portfolio.

More specifically, in the example embodiment, computer system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment. Server system 112 may be associated with any company having assets capable of being evaluated by their technical maturity.

A database server 116 is connected to database 120, which contains information on a variety of matters, as described below in greater detail. In one embodiment, database 120 is a non-centralized database stored remotely from server system 112, and can be accessed by potential users at one of client systems 114 by logging onto server system 112 through one of client systems 114. In an alternate embodiment, database 120 may be a centralized database stored on server system 112. Database 120 may store data generated as part of asset evaluation activities conducted over the network, including data relating to previously evaluated assets, response data, business value questions, technical maturity questions, and subject matter experts.

System 100 also includes a TME computer device 121, which may be connected to one or more client systems 114, and may be connected to server system 112. TME computer device 121 is interconnected to the Internet through many interfaces including a network, such as a LAN or a WAN, dial-in-connections, cable modems, wireless modems, and/or special high-speed ISDN lines. In one embodiment, TME computer device 121 is located on server system 112 and can be accessed by potential users at one of client systems 114 by logging onto server system 112 through one of client systems 114. In an alternate embodiment, TME computer device 121 may be non-centralized and is located remotely from server system 112. TME computer device 121 is capable of determining a technical maturity of a company's assets, and comparing the assets by their technical maturity as it relate to a business value of each asset.

In the example embodiment, each client system 114 is associated with a user and may be referred to as a user computer device 114. User computer device 114 may access and utilize TME computer device 121 on server system 112. In one embodiment, user computer device 114 is a computer including a web browser, such that server system 112 is accessible to user computer device 114 using the Internet. User computer device 114 is interconnected to the Internet through many interfaces including a network, such as a local area network (LAN) or a wide area network (WAN), dial-in-connections, cable modems, and special high-speed ISDN lines. User computer device 114 may also include a remote computing device, such as a web-based phone, smartphone, mobile phone, personal digital assistant (PDA), iPhone® (iPhone is a registered trademark of Apple, Incorporated located in Cupertino, Calif.), Android® (Android is a registered trademark of Google Incorporated, located in Mountain View, Calif.), and/or any device capable of executing stored computer-readable instructions. User computer device 114 can be associated with a subject matter expert or with another user utilizing system 100. User computer device 114 is configured to access service applications offered by the company and communicate with other user computer devices 114 within system 100.

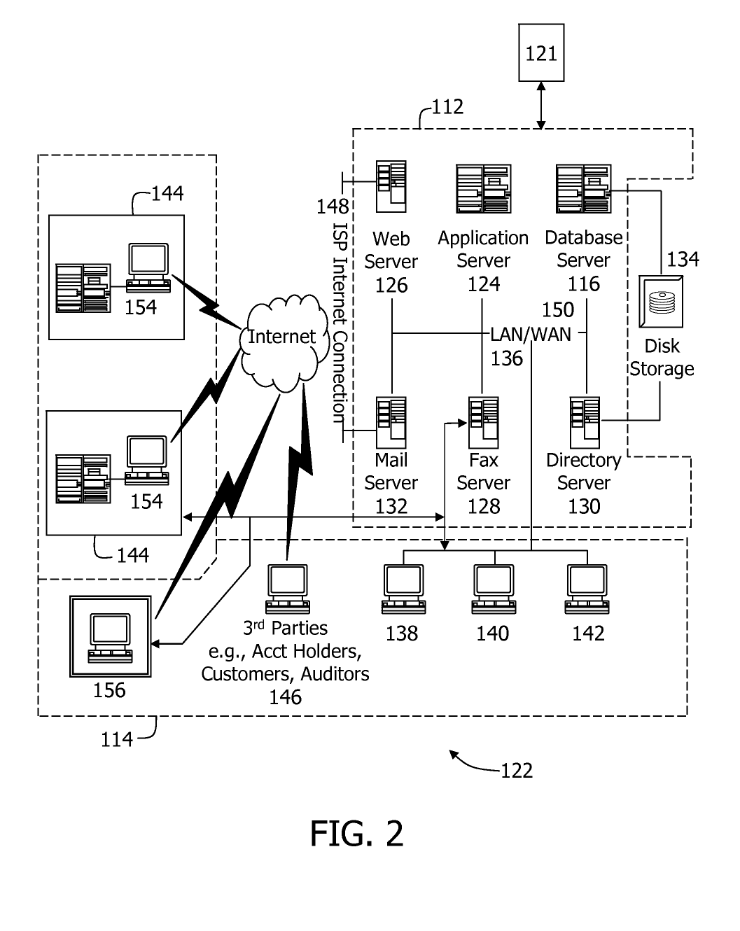

FIG. 2 is an expanded block diagram of an example embodiment of a server architecture of an asset evaluation computer system 122 including TME computer device 121 (shown in FIG. 1) in accordance with one embodiment of the present invention. Components in system 122, identical to components of system 100 (shown in FIG. 1), are identified in FIG. 2 using the same reference numerals as used in FIG. 1. System 122 includes server system 112, client systems 114, and TME computer device 121 (shown in FIG. 1). Server system 112 further includes database server 116 (shown in FIG. 1), a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

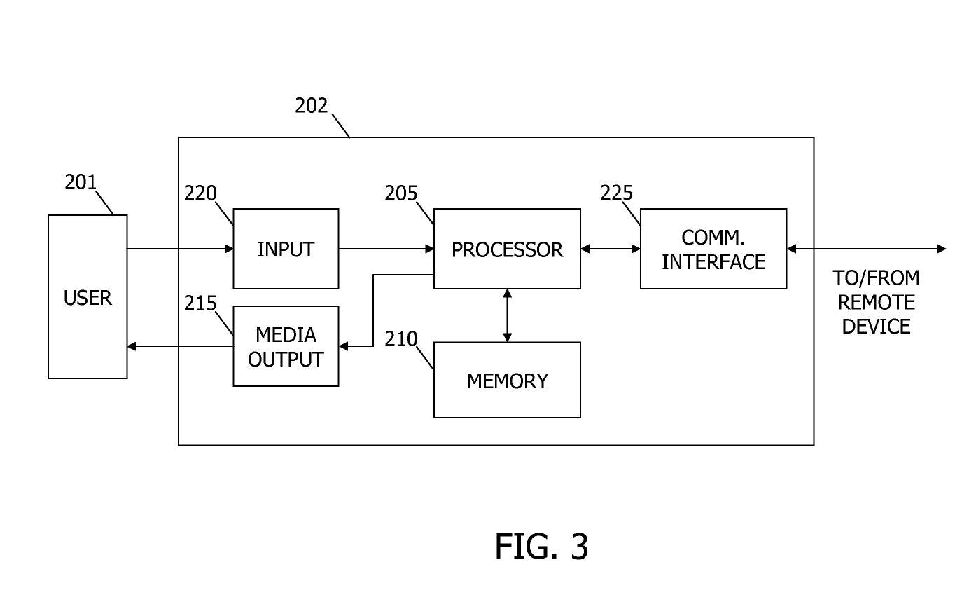

FIG. 3 illustrates an example configuration of a user computer device 202 operated by a user 201. User computer device 202 may include, but is not limited to, client systems 114, 138, 140, and 142, 146, workstation 154, and manager workstation 156 (all shown in FIG. 2).

User computer device 202 includes a processor 205 for executing instructions. In some embodiments, executable instructions are stored in a memory area 210. Processor 205 may include one or more processing units (e.g., in a multi-core configuration). Memory area 210 is any device allowing information such as executable instructions and/or other data to be stored and retrieved. Memory area 210 may include one or more computer readable media.

User computer device 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

User computer device 202 also includes an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

User computer device 202 may also include a communication interface 225, which is communicatively couplable to a remote device such as server system 112. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112 (shown in FIGS. 1 and 2), including TME computer device 121 (shown in FIGS. 1 and 2). A client application allows user 201 to interact with a server application from server system 112.

Memory area 210 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

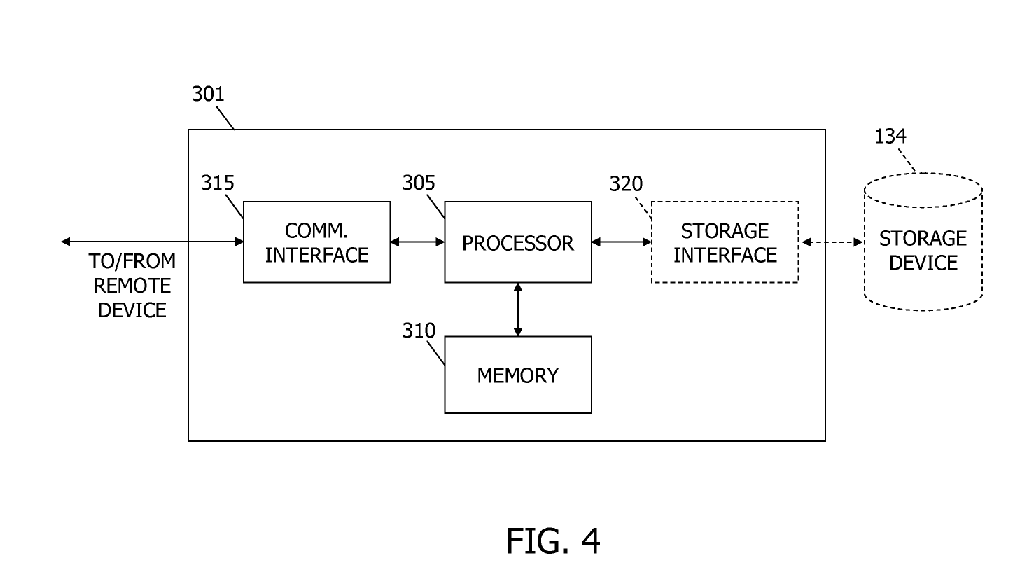

FIG. 4 illustrates an example configuration of a server system 301, such as server system 112 (shown in FIGS. 1 and 2). Server system 301 may include, but is not limited to, database server 116 (shown in FIGS. 1 and 2), TME computer device 121 (shown in FIGS. 1 and 2), application server 124, web server 126, fax server 128, directory server 130, and mail server 132 (all shown in FIG. 2).

Server system 301 includes a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as user computer device 114 (shown in FIGS. 1 and 2), user computer device 202 (shown in FIG. 3), or another sever system 301. For example, communication interface 315 may receive requests from user computer device 114 via the Internet, as illustrated in FIGS. 1 and 2.

Processor 305 may also be operatively coupled to a storage device 134 (shown in FIG. 2). Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to Server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

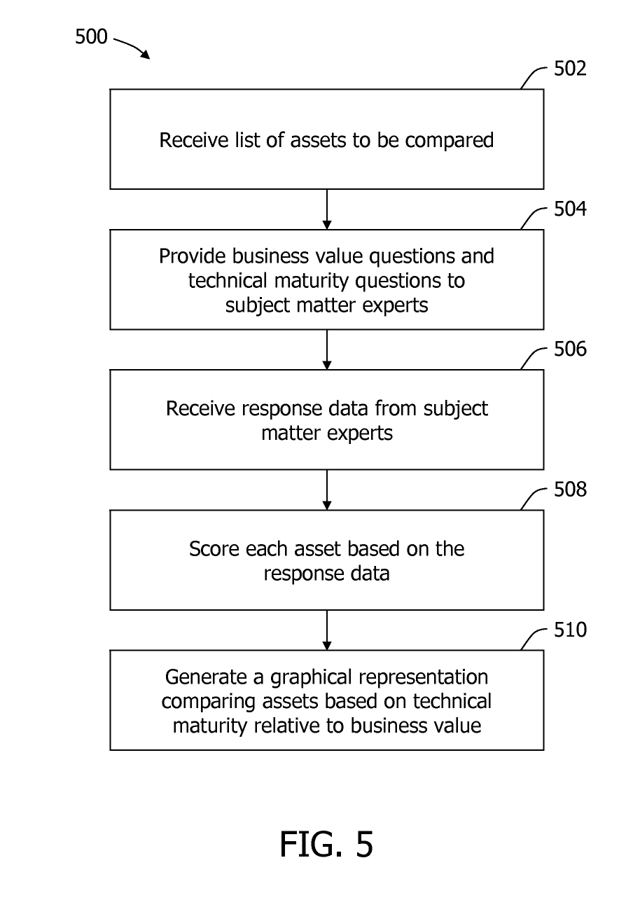

FIG. 5 is a data flow diagram 500 showing a process implemented by the TME computer device 121 (shown in FIGS. 1 and 2) for evaluating technology assets in accordance with one embodiment of the present invention. In the example embodiment, TME computer device 121 evaluates software applications. In alternate embodiments, TME computer device 121 may evaluate any assets capable of being evaluated by business value and/or technical maturity. TME computer device 121 compares pre-determined assets by determining a business value score and a technical maturity score for each pre-determined asset. TME computer device 121 uses the business value and technical maturity scores to display a graph showing the technical maturity of each asset relative to the other assets evaluated. Business value represents an overall value and impact an asset has in a market, including the amount of business and revenue the asset generates. Technical maturity represents an amount of resources and processes that the company has invested to develop and implement the asset's technology. Taken together, determining the business value and the technical maturity of an asset provides a realizable assessment that can be used to compare the assets and identify the strengths and weaknesses of each asset relative to the others.

Referring to FIG. 5, during operation, a plurality of assets are inputted 502 for TME computer device 121 to compare. The assets are selected by a user, such as user 201. User 201 may also be referred to as analyst 201. Analyst 201 uses a computer device, such as user computer device 114 (shown in FIGS. 1 and 2), to interface with and operate TME computer device 121. In the example embodiment, TME computer device 121 is stored on a server, for example, server 112 (shown in FIGS. 1 and 2).

For the specified assets to be evaluated, TME computer device 121 provides 504 a plurality of questions relating to the business value and the technical maturity of the asset. The business value questions are associated with different categories related to the business. In the example embodiment, the business questions include volume, exposure, profitability, and expected growth. In an alternate embodiment, the business questions may include any inquiries that enable the business value of an asset to be determined as described herein. The technical maturity questions are associated with the operability and capability of the technology used to implement the asset. In the example embodiment, the technical questions include categories related to reliability, availability, maintainability, customer delivery, and process governance. In an alternate embodiment, the technical questions may include any inquiries that enable the technical maturity of an asset to be determined as described herein.

To provide an accurate evaluation of assets, objectivity in the responses to the questions is desirable. To achieve objectivity, TME computer device 121 (i) poses or displays the same questions for each asset, regardless of its purpose or size of operation, (ii) poses or displays the questions to specific subject matter experts, wherein a subject matter expert is one with appropriate business or technical knowledge to accurately answer the questions (i.e. business analysts/executives answer business value questions and technology managers answer technical maturity questions and technical subject matter experts answer questions related to their fields of expertise), and (iii) provides multiple-choice answers to each question to enable multiple-tier analysis for differentiation in the scoring of the assets. The answers provide a scale of maturity and/or value starting with the lowest maturity and/or value for a specific question. In the example embodiment, each multiple-choice question has four answers. In an alternate embodiment, each question may have a “yes” or “no” answer. In other alternate embodiments, each question may have any number of answers that enables TME computer device 121 to function as described herein. In some embodiments, TME computer device 121 may include specific batches of questions for different types of assets. For example, TME computer device 121 may provide a first batch of identical questions for assets configured for customer use, while TME computer device 121 may provide a second batch of identical questions for internal assets of the company. In designing the questions, the appropriate subject matter expert is identified with each question, enabling TME computer device 121 to provide the questions to the appropriate person or group. TME computer device 121 provides the questions via server system 112 (shown in FIGS. 1 and 2) to the subject matter expert, who uses a user computer device 114 to interface with TME computer device 121.

Upon submission of the answers by the subject matter experts, TME computer device 121 receives 506 the answers to the questions, which is referred to as “response data”. In the example embodiment, TME computer device 121 stores the response data in a database, such as database 120 (shown in FIG. 1), so that it can be accessed in the future for other comparisons and/or analysis. TME computer device 121 then scores 508 each asset based on the response data. For example, TME computer device 121 determines a business value score and a technical maturity score for each asset. For scoring purposes, each question may be weighted by importance, so that when comparing multiple assets, certain characteristics may be highlighted, or given more weight, to reflect importance or significance thereof. The questions may have separate categories and sub-categories (i.e., technical reliability may include scalability, versioning, testing, process, security, etc.), which also may be separately weighted. The categories and subcategories of the questions assist in analyzing assets by determining scores for specific aspects of the assets, so that strengths and weaknesses relating to technical maturity can be determined for specific areas.

TME computer device 121 then generates 510 a graphical representation for comparing the analyzed assets relative to one another. The graph displays a point, or bubble, representing each evaluated asset. In the example embodiment, the business value is represented on the vertical axis and the technical maturity is represented on the horizontal axis. The graph enables analyst 201 to look at the technical maturity of an asset and assess the areas where the asset's technology is adequate, and where it is lacking relative to its business value.

Each asset on the graph may be selected by analyst 201 to view detailed scores at the category and sub-category levels, as well as a recommendation of a planned action to take for the asset created by TME computer device 121. The graph may also be displayed at a platform level, where a platform represents a plurality of assets associated with a specific division or business aspect of the company. For example, the graph at the platform level may indicate an overall maturity of multiple assets for a division and how that maturity relates to the business value of the division and platforms of other divisions.

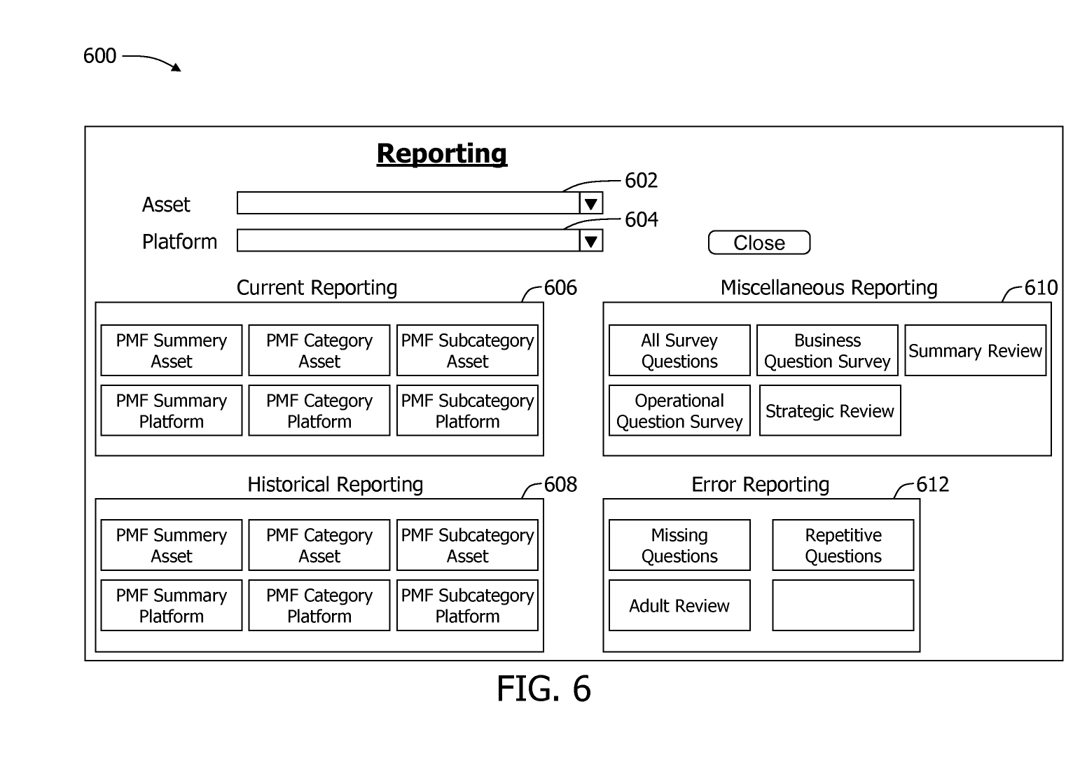

FIG. 6 is a screenshot of a reporting screen 600 from TME computer device 121 (shown in FIGS. 1 and 2) in accordance with an example embodiment of the present invention. Reporting screen 600 may be accessed via a user computer, such as user computer device 114 (shown in FIGS. 1 and 2). In the example embodiment, reporting screen 600 includes an asset drop down menu 602, a platform drop down menu 604, a current reporting section 606, a historical reporting section 608, a miscellaneous reporting section 610, and an error reporting section 612. Asset menu 602 and platform menu 604 enable a user to choose specific assets or platforms associated with a company or a portfolio. If no specific asset or platform is chosen from menus 602 or 604, TME computer device 121 evaluates all assets and platforms.

Current reporting section 606 and historical reporting section 608 enable a user to analyze the business value scores and the technical maturity scores calculated by TME computer device 121. Sections 606 and 608 include identical options and will be described together, except current reporting section 606 provides analysis of the most current data, while historical reporting section 608 provides analysis for past data collections. In the example embodiment, sections 606 and 608 each include options that provide the following: a summary at asset level, a summary at platform level, an asset summary at category level, a platform summary at category level, an asset summary at sub-category level, and a platform summary at sub-category level.

The summary at asset level option provides the business value and technical maturity scores calculated by TME computer device 121 for assets associated with a company or a portfolio. As described above, a user may select one or more specific assets for viewing using asset menu 602. If no asset is chosen, scores for all assets are provided.

The summary at platform level option provides the business value and technical maturity scores calculated by TME computer device 121 for platforms associated with a company or a portfolio. As described above, an analyst may select one or more specific platforms for viewing using platform menu 604. If no platform is chosen, the scores for all platforms are provided. If the user does not know the name of a particular platform to be analyzed, the user may select an asset and TME computer device 121 provides a list of each platform that the asset impacts.

The asset summary at category level option provides the business value and technical maturity scores for an asset, separated by category. As described above, a user may select one or more specific assets for viewing using asset menu 602. If no asset is chosen, the scores for all assets are provided.

The platform summary at category level option provides the business value and technical maturity scores for a platform, separated by category. As described above, a user may select one or more specific platforms for viewing using platform menu 604. If no platform is chosen, the scores for all platforms are provided.

The asset summary at sub-category level option provides the business value and technical maturity scores for an asset, separated by sub-category. As described above, a user may select one or more specific assets for viewing using asset menu 602. If no asset is chosen, the scores for all assets are provided.

The platform summary at sub-category level option provides the business value and technical maturity scores for a platform, separated by sub-category. As described above, a user may select one or more specific platforms for viewing using platform menu 604. If no platform is chosen, the scores for all platforms are provided.

Miscellaneous reporting section 610 enables a user to provide and/or review the questions presented to the subject matter experts for determining business value and technical maturity scores. Miscellaneous reporting section 610 includes options that provide: all survey questions, operational questions, business questions, strategic review, and summary review.

The all survey questions option provides a report that includes all active questions that may be sent to the subject matter experts. The operational question survey option provides a report that includes all active technical maturity questions. If an asset or a platform is chosen from either menu 602 or 604, then only technical maturity questions relating to the selection will be displayed. The business value question survey option provides a report that includes all active business value questions. If an asset or a platform is chosen from either menu 602 or 604, then only business value questions relating to the selection will be displayed.

The strategic review option provides the percentage of assets associated with each multiple-choice question. In the example embodiment, each multiple-choice question has four answers and the strategic review option provides the percentage of assets associated with each answer 1-4. The summary review option provides data used to populate a grid matrix.

Error reporting section 612 provides options for the user to report errors or inconsistencies with TME computer device 121. The options include: missing questions, audit review, and repetitive questions. The missing questions and repetitive options enable a user of TME computer device 121 to provide notification of any questions that are missing or repetitive. A manager of TME computer device 121 receives the notifications and determines how to remedy the issues. The audit review option assists in creating the metrics of TME computer device 121 during an audit cycle.

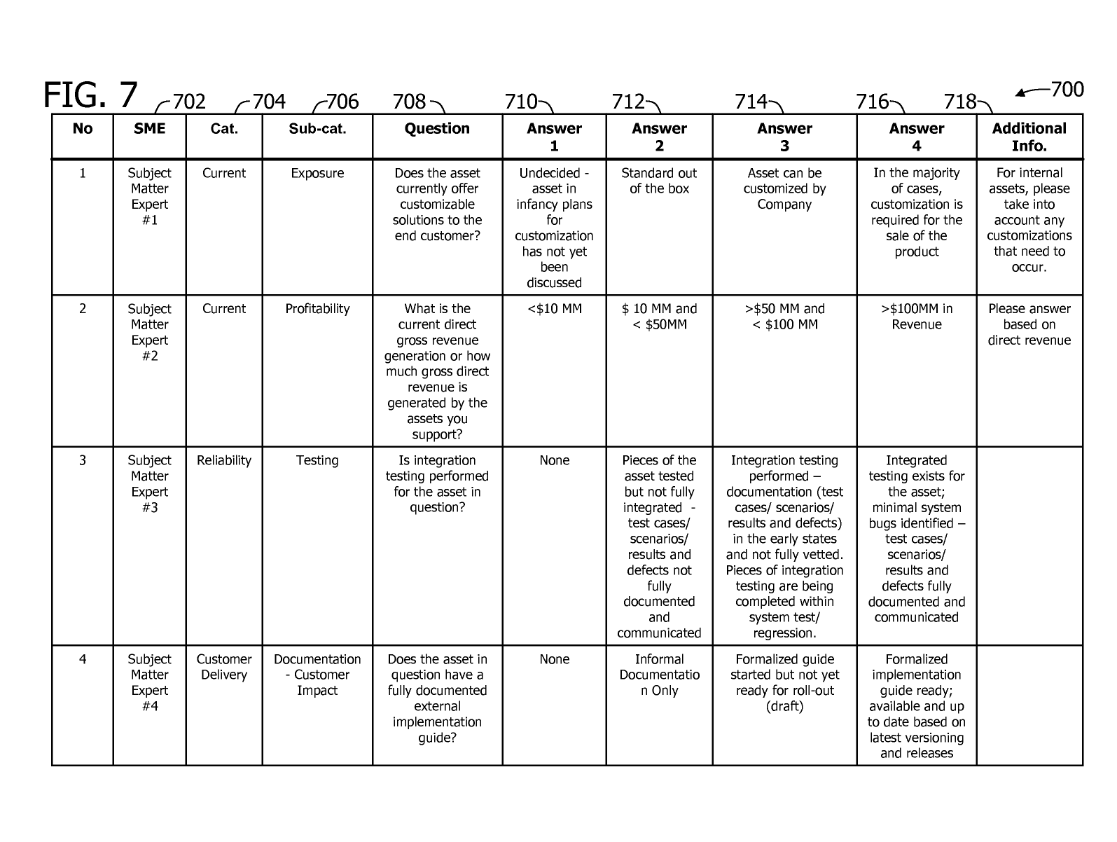

FIG. 7 is a chart 700 illustrating exemplary questions and answers posed to subject matter experts by TME computer device 121 (shown in FIGS. 1, 2, and 6) in accordance with one embodiment of the present invention. In the exemplary embodiment, TME computer device 121 includes an individual responsible column 702, a question category column 704, a subcategory column 706, a question column 708, an answer 1 column 710, an answer 2 column 712, an answer 3 column 714, an answer 4 column 716, and an additional information column 718. Chart 700 can be viewed by analyst 201 (shown in FIG. 3) by accessing the “all survey questions” option on reporting screen 600 (shown in FIG. 6). In some embodiments, chart 700 may be sorted by a specified column for a detailed analysis by analyst 201.

In the example embodiment, individual responsible column 702 includes the subject matter expert having the appropriate knowledge regarding a particular aspect of the asset to answer a particular question. For each question, category column 704 includes a category related to business value or technical maturity that each question is associated with. In the example embodiment shown in FIG. 7, question numbers 1 and 2 are associated with the category “current”, which is a category relating to the current business value of the asset. Questions may also be associated with a category “future”, which requires the subject matter expert to project an answer regarding an asset's value or performance a given number of months and/or years in the future. Question numbers 3 and 4 are associated with the categories “reliability” and “customer delivery”, which are categories relating to the technical maturity of the asset.

Subcategory column 706 is a more specific version of category column 704. In the example embodiment, question numbers 1 and 2 are associated with the subcategories “exposure” and “profitability”, respectively, and are both business value subcategories of the “current” category described above. Question number 3 is associated with the subcategory “testing”, which is a technical maturity subcategory that is associated with the category “reliability”. Question number 4 is associated with the subcategory “documentation—customer impact”, which is a technical maturity subcategory that is associated with the category “customer delivery”.

Question column 708 includes the actual questions posed to the subject matter experts. Answer columns 710, 712, 714, and 716 include each of the multiple-choice answers to the questions. The answers assist in enabling consistency and objectivity for the subject matter experts who answer the questions so accurate evaluation of assets may occur. Additional information column 718 may include information and/or explanation for a question to assist the subject matter expert to properly answer the question.

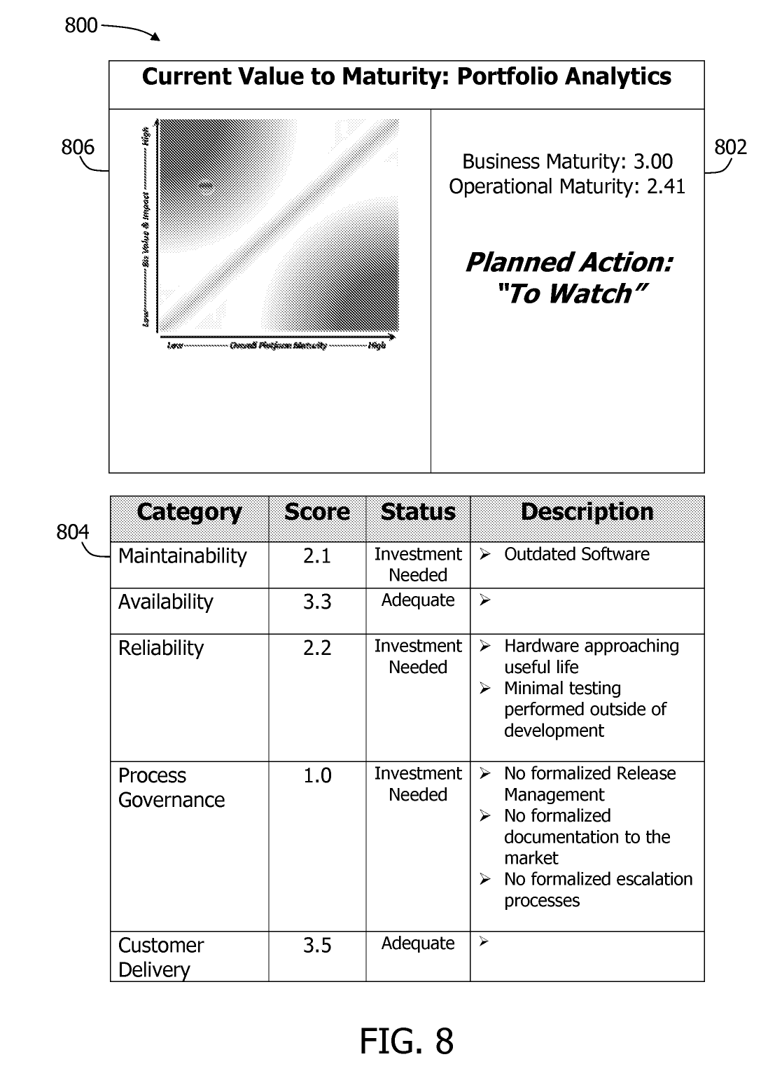

FIG. 8 shows an example summary report at asset level 606 (shown in FIG. 6) as outputted by TME computer device 121 (shown in FIGS. 1, 2, and 6) in accordance with the present invention. In the example embodiment, analyst 201 (shown in FIGS. 3 and 5) using TME computer device 121 selects a specific asset to be analyzed from asset menu 602 (shown in FIG. 6) and then selects the summary at asset level option from current reporting section 606 (shown in FIG. 6). Included in summary 800 is box 802 that displays the asset's business value score, technical maturity score, and a planned action to take for the asset; box 804 that contains a list of technical maturity categories being analyzed, and their associated scores, statuses, and descriptions; and box 806 that contains a graphical representation of the business value of the asset relative to its technical maturity.

Box 802 displays the business value score and the technical maturity score for the selected asset. Each score is calculated based on the response data provided by various subject matter experts, taking into consideration any weight added to certain questions. The specific values of the scores merely provide a basis for the scores to be compared to one another, and to other assets. The specific values also provide an indication of the disparity or relative alignment of the overall business value and/or technical maturity of the specific asset. An optimal state is to have the absolute difference between the business value and technical maturity scores approach zero. The optimal state is a level of investment in the technical maturity of the asset that is proportional with the business value derived from the asset.

Box 802 also includes a planned action for the asset recommended by TME computer device 121. Specific planned actions may be specified by a user of TME computer device 121, and may be based on specific scoring levels for the asset. In the example embodiment, planned actions include “invest”, “watch”, and “balanced”. “Invest” indicates that the business value of the asset is much higher than the technical maturity, so the company needs to invest in technology to optimize the asset's value. “Watch” indicates that although the business value is higher than the technical maturity for an asset, they are relatively close in value. No major investment in the technology is immediately necessary, but the asset should be periodically reviewed to ensure the business value does not further exceed the technical maturity. “Balanced” indicates that the technical maturity is equal to or greater than the business value of the asset and no further investment is necessary. Other example actions are also possible if the technical maturity is greater than the business value. These example actions may include “kill”, “increase sales”, or “divest”. “Kill” indicates that the company should consider removing the asset. “Increase sales” indicates that the company should focus on increasing the business value of the asset by finding more opportunities to leverage the asset. “Divest” indicates that some of the technical complexity should be removed from the system, because it is not necessary.

Box 804 includes a list of specific categories associated with the technical questions and provides the scores for each category. The score column indicates the areas of strength and weakness for specified categories of the asset. A status (i.e. “investment needed” or “adequate”) and a description of why the status is chosen are provided for each of the categories.

Box 806 includes a graph illustrating the business value of the asset relative to the technical maturity. The graph includes a line spanning from the bottom-left corner of the graph to the top-right corner that indicates an optimum business value to technical maturity ratio for an asset. In the example embodiment shown in FIG. 8, the point representing the asset lies above the optimization line, indicating that the business value is greater than the technical maturity, as is detailed in box 802. The graph includes a section near the line that is light in color. The asset's bubble being in this lightly-colored section indicates that the asset has an acceptable technical maturity. In an alternate embodiment, the graph may be provided in color. The darkest portions of the graph are red, which blends into orange and then yellow at the lightest points, while the optimization line is green. The color scheme serves as indication of very poor balance levels (i.e. red), slightly low balance levels (i.e. orange to yellow), and asset is balanced (i.e. green).

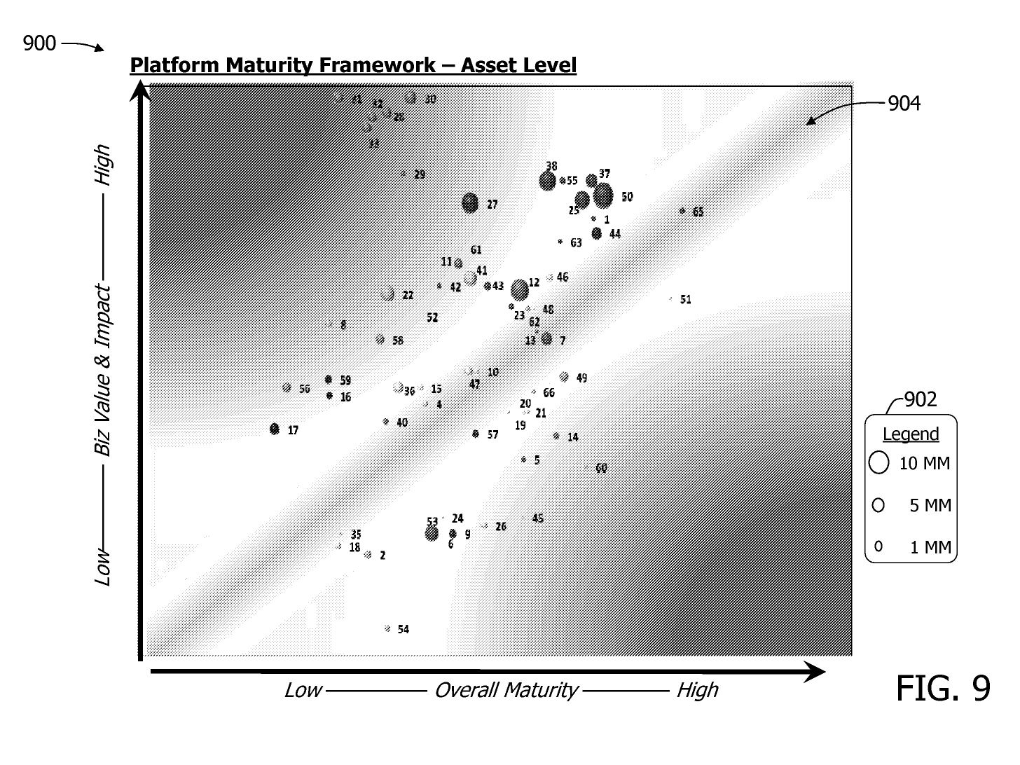

FIG. 9 is an example graph 900 created by TME computer device 121 (shown in FIGS. 1 and 2) illustrating the maturity of a plurality of assets relative to one another. Graph 900 includes a plurality of points, or bubbles (i.e., 1-66), that represent different assets and a list that identifies each point. In the example embodiment, sixty-six assets are compared; however, any number of platforms may be selected for comparison.

In the example embodiment, the bubbles on graph 900 have different sizes and shades of color. The size of a particular bubble generally represents the amount of money the company is spending on a particular asset, which may be indicative of the overall importance of that asset to the company. In the example embodiment, a legend 902 is included in graph 900 to provide a reference of the amount of money being spent relative to the size of a bubble. For example, legend 902 indicates that about $10 million is being spent on each of the assets associated with bubbles 22, 25, 41, and 53, while only about $1 million is being spent on the assets associated with bubbles 2, 8, 43, and 46. The bubbles also may be shaded to illustrate which assets are related to certain platforms or particular parts of the business. For example, darker shaded bubbles 1, 25, 37, 38, 44, 50, 55, and 65 all represent assets associated with one platform, while lighter shaded bubbles 28, 30, 31, 32, and 33 are assets associated with a different platform. In an alternate embodiment, graph 900 and bubbles 1-66 may be provided in color to better represent their relationships. An analyst using TME computer device 121 may select a particular bubble on graph 900 to see more details for an asset. For example, selecting a bubble may display the summary at asset level 800 (shown in FIG. 8).

Graph 900 enables the comparison of one or more assets associated with a company or portfolio by plotting each asset based on its business value relative to its technical maturity, while also illustrating which assets are related to different aspects of the business and the amount of money being spent on each asset. Graph 900 includes an optimization line 904 that indicates an ideal or optimized ratio of business value relative to technical maturity for an asset. For example, darker shaded bubbles 1, 25, 37, 38, 44, 50, 55, and 65 have a high business value and an almost equally high technical maturity. Viewing any of these assets in the summary at asset level 800, TME computer device 121 would likely provide a planned action of “watch” or “balanced” because these assets are close to optimization line 904 on graph 900. This indicates that the amount of money invested in technology is proportional and sufficient to the amount of business associated with for these assets. The large size of most of the bubbles in this group indicate that the company spends more money in this area of business than any other, so it is likely the most important. Inspecting lighter shaded bubbles 28, 30, 31, 32, and 33 indicates that these assets are of medium importance to the overall business of the company. Their positioning on graph 900 shows that these assets generate a large amount of business value as compared to the maturity of the technology associated with them. This would indicate to a company that it needs to invest much more heavily in developing these assets to maximize their potential value. For each of these assets, the summary at asset level 800 would likely provide a planned action of “invest”.

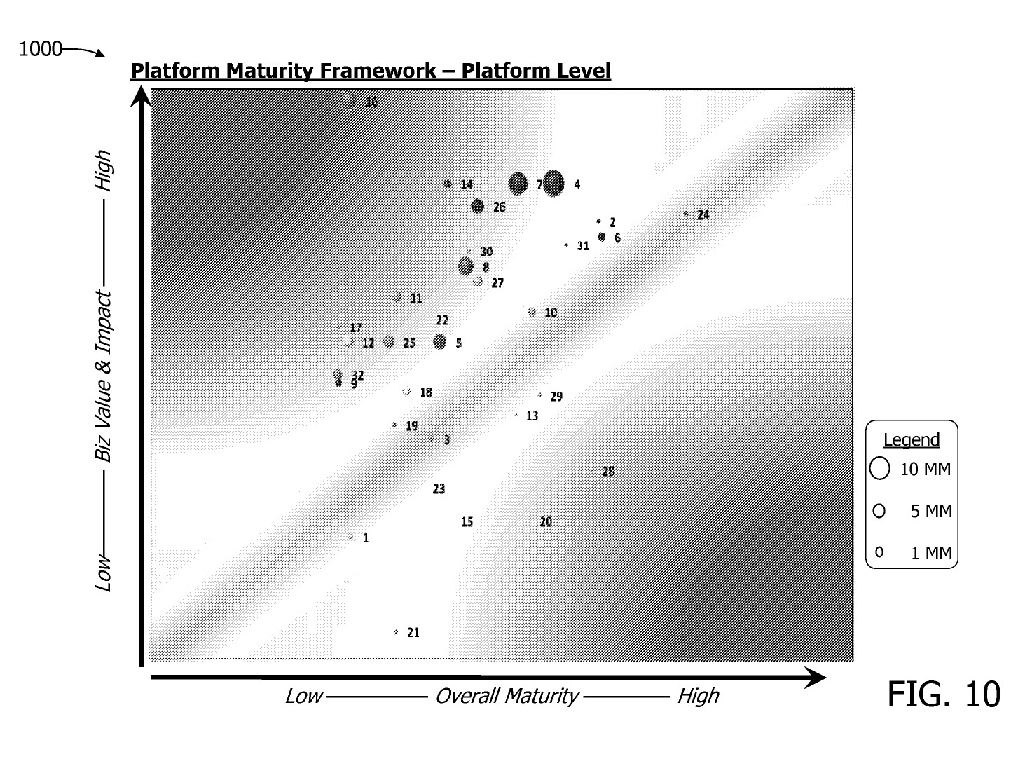

FIG. 10 is an example graph 1000 generated by TME computer device 121 (shown in FIGS. 1 and 2) illustrating the maturity of a plurality of asset platforms relative to one another. Graph 1000 operates similarly to graph 900 (shown in FIG. 9) and includes a plurality of points (i.e., 1-32) that represent different asset platforms and a list that identifies each point. A platform is a combination of multiple assets related to a particular aspect or division of a company's business. In the example embodiment, 32 asset platforms are compared; however, any number of asset platforms may be selected for comparison. For example, bubble 4 on graph 1000 represents the overall maturity of a combination of bubbles 1, 25, 37, 38, 44, 50, 55, and 65 of graph 900, and bubble 16 in graph 1000 represents bubbles 28, 30, 31, 32, and 33 of graph 900. Accordingly, graph 1000 allows a user of TME computer device 121 to compare the technical maturity of multiple asset platforms associated with different aspects of a company's business and how the maturity levels of each aspect compare to each other and the overall importance of the asset platform to the business.

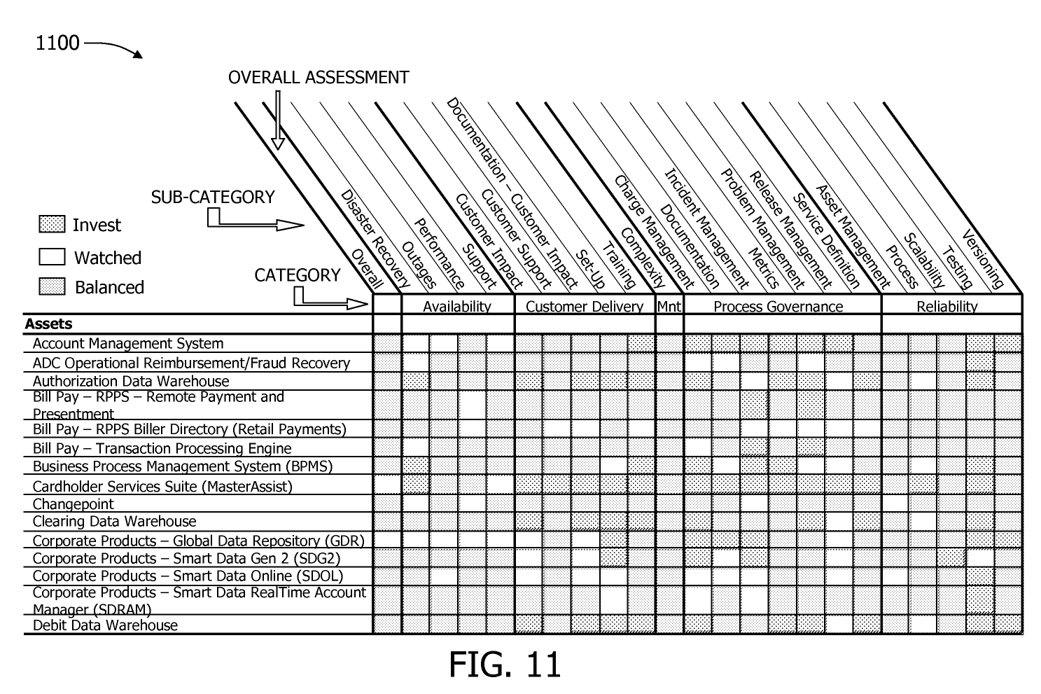

FIG. 11 is a screenshot 1100 generated by TME computer device 121 (shown in FIGS. 1 and 2) illustrating the technical maturity scores for a plurality of assets at a category and a sub-category level and provides a planned action for each. In the example embodiment, the planned actions for each asset provided by TME computer device 121 are illustrated by shaded boxes. For example, “invest” is represented by the darkest boxes, “balanced” by the medium-shaded boxes, and “watch” by the lightest boxes. The first column nearest the asset list illustrates the overall technical maturity associated with each asset, while the remaining columns illustrate areas of strength and weakness at the sub-category level.

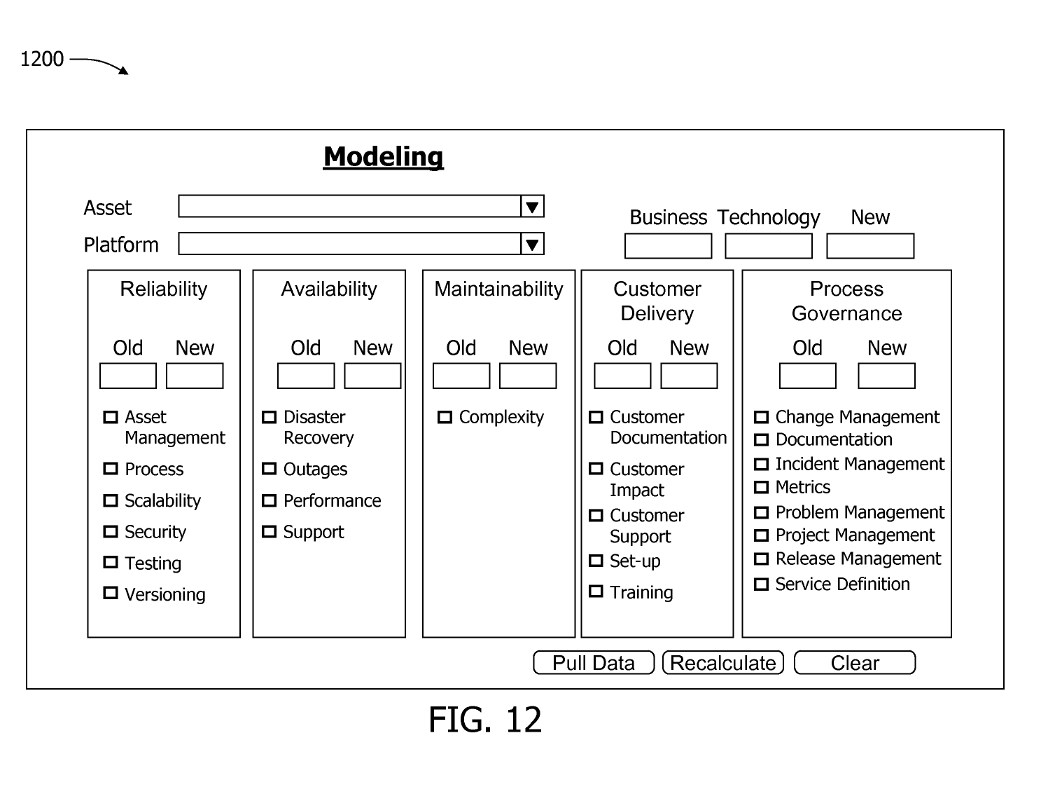

FIG. 12 is a screenshot of a modeling function 1200 of TME computer device 121 (shown in FIGS. 1 and 2). Modeling function 1200 enables a user of TME computer device 121 to input incremental changes in the maturity scores at the sub-category level for an asset or a platform, and predict how those incremental changes might affect the maturity scores at the category and sub-category levels. In effect, modeling function 1200 assists in determining which areas it would be worthwhile to invest more in technology versus which areas, if invested in, may not provide a worthwhile return on the investment.

The above-described methods and systems provide for determining a technical maturity of a company's assets, and comparing the assets by their technical maturity as related to their relative business values. The methods and systems described herein facilitate evaluating assets in an accurate and objective manner and enable comparison of specific assets relative to other specific assets associated with a company. Moreover, the methods and systems described herein facilitate (i) receiving, by a technology maturity evaluation (TME) computer device, a list of technology assets to be compared, wherein the list is input by a user; (ii) providing, by the TME computer device, business value questions and technical maturity questions to appropriate subject matter experts through at least one user computer device, wherein the business value questions and technical maturity questions are identical for all assets being compared and all have multiple-choice answers; (iii) receiving, at the TME computer device, response data from the subject matter experts by the at least one user computer device, wherein the response data is data associated with the answers to the business value questions and the technical maturity questions provided by the subject matter experts; (iv) determining a business value score and a technical maturity score for each asset based on the response data provided by the subject matter experts; and (v) generating a graphical representation comparing the technical maturity score of each asset to the business value score of each asset relative to all assets chosen for comparison.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A technology maturity evaluation (TME) computer device for evaluating a technology asset of an entity, said TME computer device comprising:
a memory device for storing data including a plurality of business value questions and a plurality of technical maturity questions, wherein the business value questions are configured to evaluate an overall value and impact an asset has in a marketplace, and wherein the technical maturity questions are configured to evaluate an amount of resources invested to develop and implement the asset; and
a processor in communication with said memory device, said TME computer device programmed to:
receive an asset identifier identifying an asset selected for evaluation;
electronically display the plurality of business value questions and the plurality of technical maturity questions stored within the memory device for the selected asset, wherein each question of the plurality of business value questions and the plurality of technical maturity questions is designated for a response by a subject matter expert;
receive response data from each of the subject matter experts designated for responding to each of the business value questions and technical maturity questions electronically displayed; and
calculate a business value score and a technical maturity score for the selected asset based at least in part on the response data, wherein the business value score represents an overall value and impact the selected asset has in a marketplace, and wherein the technical maturity score represents an amount of resources invested to develop and implement the selected asset.

2. A TME computer device in accordance with claim 1, wherein said TME computer device is further programmed to:
display a list of asset identifiers identifying a plurality of assets; and
receive a plurality of asset identifiers identifying a plurality of assets selected for evaluation,
wherein the business value score and the technical maturity score are calculated for each of the selected plurality of assets.

3. A TME computer device in accordance with claim 2, wherein said TME computer device is further programmed to:
generate a graphical representation comparing the technical maturity score and the business value score of each asset of the selected plurality of assets relative to all other assets included within the selected plurality of assets.

4. A TME computer device in accordance with claim 2, wherein said TME computer device is in communication with a user interface, and said TME computer device is further programmed to display on the user interface the same plurality of business value questions and technical maturity questions for each asset of the selected plurality of assets.

5. A TME computer device in accordance with claim 1, wherein said TME computer device is further programmed to display a plurality of multiple-choice answers for each question of the plurality of business value questions and the plurality of technical maturity questions, wherein each answer of the plurality of multiple-choice answers includes a pre-determined value used to calculate the business value score and the technical maturity score.

6. A TME computer device in accordance with claim 1, wherein each question of the plurality of business value questions and the plurality of technical maturity questions includes a weighted value to differentiate an impact of each question relative to the plurality of business value questions and the plurality of technical maturity questions.

7. A TME computer device in accordance with claim 1, wherein the selected asset includes a plurality of assets, and said TME computer device is further programmed to:
display a list of platform identifiers identifying a plurality of platforms, wherein a platform includes a set of assets from the plurality of assets, each set of assets related to a specific business aspect of the entity;
receive a plurality of platform identifiers identifying a plurality of platforms selected for evaluation, wherein the business value score and the technical maturity score are calculated for each platform of the selected plurality of platforms; and
calculate a business value score and a technical maturity score for each platform of the selected plurality of platforms.

8. A TME computer device in accordance with claim 7, wherein said TME computer device is further programmed to:
generate a graphical representation comparing the technical maturity score and the business value score of each platform of the selected plurality of platforms relative to all other platforms included within the selected plurality of platforms.

9. A TME computer device in accordance with claim 1, wherein each question of the plurality of business value questions and the plurality of technical maturity questions is associated with a category, wherein a category includes at least one of maintainability, availability, reliability, process governance, and customer delivery.

10. A TME computer device in accordance with claim 9, wherein said TME computer device is further programmed to:
receive a projected score for at least one category inputted by a user; and
calculate a projected business value score and a projected technical maturity score for the asset based on the projected category score.

11. A computer-implemented method for evaluating a technology asset of an entity using a technology maturity evaluation (TME) computer device, wherein the TME computer device includes a memory device and a processor, said method comprising:
receiving, by the TME computer device, an asset identifier identifying an asset selected for evaluation;
electronically displaying a plurality of business value questions and a plurality of technical maturity questions, wherein each question of the plurality of business value questions and the plurality of technical maturity questions is designated for a response by a subject matter expert, and wherein the business value questions are configured to evaluate an overall value and impact an asset has in a marketplace and the technical maturity questions are configured to evaluate an amount of resources invested to develop and implement the asset;
receiving, by the TME computer device, response data from each of the subject matter experts designated for responding to each of the business value questions and technical maturity questions electronically displayed; and
calculating a business value score and a technical maturity score for the selected asset based at least in part on the response data, wherein the business value score represents an overall value and impact the selected asset has in a marketplace, and wherein the technical maturity score represents an amount of resources invested to develop and implement the selected asset.

12. A computer-implemented method in accordance with claim 11, further comprising:
displaying a list of asset identifiers identifying a plurality of assets; and
receiving a plurality of asset identifiers identifying a plurality of assets selected for evaluation, wherein the business value score and the technical maturity score are calculated for each of the selected plurality of assets.

13. A computer-implemented method in accordance with claim 12, further comprising:
generating a graphical representation comparing the technical maturity score and the business value score of each asset of the selected plurality of assets relative to all other assets included within the selected plurality of assets.

14. A computer-implemented method in accordance with claim 12, further comprising:
communicating with a user interface to display to each subject matter expert the same plurality of business value questions and technical maturity questions for each asset of the selected plurality of assets.

15. A computer-implemented method in accordance with claim 11, further comprising:
displaying a plurality of multiple-choice answers for each question of the plurality of business value questions and the plurality of technical maturity questions, wherein each answer of the plurality of multiple-choice answers includes a pre-determined value used to calculate the business value score and the technical maturity score.

16. A computer-implemented method in accordance with claim 11, wherein each question of the plurality of business value questions and the plurality of technical maturity questions includes a weighted value to differentiate an impact of each question relative to the plurality of business value questions and the plurality of technical maturity questions.

17. A computer-implemented method in accordance with claim 11, wherein the selected asset includes a plurality of assets, said method further comprising:
displaying a list of platform identifiers identifying a plurality of platforms, wherein a platform includes a set of assets from the plurality of assets related to a specific business aspect of the entity;
receiving a plurality of platform identifiers identifying a plurality of platforms selected for evaluation, wherein the business value score and the technical maturity score are calculated for each platform of the selected plurality of platforms;
calculating a business value score and a technical maturity score for each platform of the selected plurality of platforms; and
generating a graphical representation comparing the technical maturity score and the business value score of each platform of the selected plurality of platforms relative to all other platforms included within the selected plurality of platforms.

18. A computer-implemented method in accordance with claim 11, wherein each question of the plurality of business value questions and the plurality of technical maturity questions is associated with a category, wherein a category includes at least one of maintainability, availability, reliability, process governance, and customer delivery.

19. A computer-implemented method in accordance with claim 11, further comprising:
receiving a projected score for at least one category inputted by a user; and
calculating a projected business value score and a projected technical maturity score for the asset based on the projected category score.

20. One or more non-transitory computer-readable storage media having computer-executable instructions embodied thereon for evaluating a technology asset of an entity by a technology maturity evaluation (TME) computer device, wherein the TME computer device includes a memory device and a processor, wherein when executed by said processor, said computer-executable instructions cause said processor to:
receive an asset identifier identifying an asset selected for evaluation;
electronically display the plurality of business value questions and the plurality of technical maturity questions stored within the memory device for the selected asset, wherein each question of the plurality of business value questions and the plurality of technical maturity questions is designated for a response by a subject matter expert, and wherein the business value questions are configured to evaluate an overall value and impact an asset has in a marketplace and the technical maturity questions are configured to evaluate an amount of resources invested to develop and implement the asset;
receive response data from each of the subject matter experts designated for responding to each of the business value questions and technical maturity questions electronically displayed; and
calculate a business value score and a technical maturity score for the selected asset based at least in part on the response data, wherein the business value score represents an overall value and impact the selected asset has in a marketplace, and wherein the technical maturity score represents an amount of resources invested to develop and implement the selected asset.

21. The one or more non-transitory computer-readable storage media in accordance with claim 20, wherein said computer-executable instructions further cause said processor to:
display a list of asset identifiers identifying a plurality of assets;
receive a plurality of asset identifiers identifying a plurality of assets selected for evaluation, wherein the business value score and the technical maturity score are calculated for each of the selected plurality of assets; and
generate a graphical representation comparing the technical maturity score and the business value score of each asset of the selected plurality of assets relative to all other assets included within the selected plurality of assets.

22. The one or more non-transitory computer-readable storage media in accordance with claim 20, wherein said computer-executable instructions further cause said processor to:
display a plurality of multiple-choice answers for each question of the plurality of business value questions and the plurality of technical maturity questions, wherein each answer of the plurality of multiple-choice answers includes a pre-determined value used to calculate the business value score and the technical maturity score.

23. The one or more non-transitory computer-readable storage media in accordance with claim 20, wherein the selected asset includes a plurality of assets, said computer-executable instructions further cause said processor to:
display a list of platform identifiers identifying a plurality of platforms, wherein a platform includes a set of assets from the plurality of assets, each set of assets related to a specific business aspect of the entity;
receive a plurality of platform identifiers identifying a plurality of platforms selected for evaluation, wherein the business value score and the technical maturity score are calculated for each platform of the selected plurality of platforms; and
calculate a business value score and a technical maturity score for each platform of the selected plurality of platforms.
